(19) United States
(12) Patent Application Publication
(10) Pub. No.: US 2009/0249341 A1
(43) Pub. Date: Oct. 1, 2009

(54) PROCESSING ELEMENT, CONTROL UNIT, PROCESSING SYSTEM INCLUDING PROCESSING ELEMENT AND CONTROL UNIT, AND DISTRIBUTED PROCESSING METHOD

(75) Inventor: Mitsunori KUBO, OSAKA (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: OLYMPUS CORPORATION, TOKYO (JP)

(21) Appl. No.: 12/442,276

(22) PCT Filed: Oct. 15, 2007
(86) PCT No.: PCT/JP2007/070072

§ 371 Date: Mar. 20, 2009

(51) Int. Cl. G06F 9/30; G06F 9/46

(52) U.S. Cl. 718/100; 712/220; 712/E09.016

(57) ABSTRACT

A processing system has a processing element and a control unit. The processing element has a processing section which carries out a specific function, a communication section which outputs to an outside, function information related to the specific function according to a request from the outside, and a data holding section which holds the function information. The control unit has a communication section which outputs the function information of the processing element connected, according to a request from the outside.

### TECHNICAL FIELD

The present invention relates to a processing element, a control unit, a processing system including the processing element and the control unit, and a distributed processing method.

### BACKGROUND ART

At the time of executing a process which includes a plurality of steps, the following three methods (1), (2), and (3) have hitherto been considered.

(1) A method of solving all steps by software
(2) A method of replacing some of the steps (functions) by hardware
(3) A method of solving everything by hardware

In method (1), for instance, in a general-purpose CPU, all steps are described as software. When each step is executed by a subroutine or a thread by one computer program, a case of executing by separate computer programs and carrying out communication between the computer programs is taken into consideration.

Moreover, in method (2), for instance, a part of a process of the maximum load is accelerated by using hardware such as DSP (Digital Signal Processor). In a multimedia codec process, it is the most common method. Moreover, method (3) is a method of executing all the steps by using hardware. As a parallel processing system, for example, a system proposed in Patent Literature 1 is available.

Patent Literature 1: Japanese Patent Application Laid-open Publication No. Hei 10-334055

### DISCLOSURE OF THE INVENTION

### Problems to be Solved by the Invention

For example, a certain processing element (client processing element) making a request for a process A which is formed by step 1, step 2, step 3, and step 4 is taken into consideration.

At this time, a process element which accepts the request is called as a server processing element. When the server processing element knows information of all processing elements in a network, a location of a processing element which is specialized in a process of steps from step 1 to step 4 is to be notified.

However, in this method, the server processing element is required to hold all information on the network. Therefore, expandability becomes low, and cost become high.

The present invention is made in view of the abovementioned circumstances, and an object of the present invention is to provide a processing system which has a high expandability, and which can be realized at a low cost, and a processing element, a control unit, and a distributed processing method which are used this system.

### Means for Solving the Problems

For solving the abovementioned issues and achieving the object, according to the present invention, there can be provided a processing element including a processing section which carries out a specific function, a communication section which outputs to an outside, function information related to the specific function according to a request from the outside, and a data holding section which holds the function information.

Moreover, according to a preferable aspect of the present invention, it is desirable that a control unit which is connected to the processing element includes a communication section which outputs function information related to a specific function which is carried out by the processing element which is connected, according to a request from an outside.

Moreover, according to a preferable aspect of the present invention, it is desirable that the communication section can inquire to the other control unit, about function information of a processing element connected to the other control unit.

Moreover, according to a preferable aspect of the present invention, it is desirable that the control unit detects the processing element connected to or disconnected from the control unit.

Moreover, according to a preferable aspect of the present invention, it is desirable that a processing system includes a processing element and a control unit, and the processing element includes a processing section which carries out a specific function, a communication section which outputs to an outside, function information related to the specific function, according to a request from the outside, and a data holding section which holds the function information, and the control unit has a communication section which outputs the function information of the processing element connected, according to a request from an outside.

According to a preferable aspect of the present invention, it is desirable that the control unit has a data holding section which acquires via the communication section, the function information of the processing element connected to the control unit, and holds the function information acquired.

Moreover, according a preferable aspect of the present invention, it is desirable that the control unit detects the processing element that is connected or disconnected, and creates or updates processing-element connection information for controlling at least the function information of the processing element which is connected to the control unit, and receives an execution request related to a specific service, and acquires information of a task which forms the service, and makes a judgment about an execution of the service by using the processing element which is connected to the control unit, by referring to the processing-element connection information, and acquires a task-execution transition information for executing the task which forms the service, based on a judgment result about the execution of the service, and the processing element connected to the control unit carries out the function, according to the task-execution transition information.

Moreover, according to a preferable aspect of the present invention, it is desirable that the communication section of the control unit makes an inquiry about the function information which is held in the other control unit, based on the judgment result about the execution of the service, and the processing element which is connected to the other control unit also carries out the function, according to the task-execution transition information

Moreover, according a preferable aspect of the present invention, there can be provided a distributed processing method which uses a control unit and a processing element which carries out a specific function including a data holding step in processing element of holding function information related to the specific function in the processing element, a processing-element communication step of outputting to an outside the function information, according to a request from an outside of the processing element, and a control-unit communication step of outputting the function information, according to a request from an outside of the control unit.

Moreover, according a preferable aspect of the present invention, it is desirable that the distributed processing method further includes a data holding step in control unit of acquiring the function information of the processing element which is connected to the control unit, and holding the function information acquired in the control unit.

Moreover, according to a preferable aspect of the present invention, it is desirable that the distributed processing method includes a processing-element checking step of detecting the processing element that is connected to or disconnected from the control unit, a processing-element connection information acquisition step of acquiring or updating processing-element connection information for controlling at least the function information of the processing element which is connected to the control unit, a service-execution request receiving step of receiving an execution request related to a service, a service-task correspondence information acquisition step of acquiring information which indicates a task which forms the service, a service-execution judging step of judging about an execution of the service based on one of or both the function information and processing-element connection information related to the processing element which is connected to the control unit, by referring to information indicating task which forms the service, a task-execution transition information acquisition step of acquiring task-execution transition information for executing the task forming the service, based on a judgment result of the service-execution judging step, and a processing-element execution step of carrying out the function, according to the task-execution transition information by the processing element which is connected to the control unit.

Moreover, according to a preferable aspect of the present invention, it is desirable that at the processing-element connection information acquisition step, processing-element connection information related to other control unit within a predetermined range connected to the control unit is acquired or updated.

Moreover, according to a preferable aspect of the present invention, it is desirable that the other control unit within the predetermined range connected to the control unit is determined based on a communication distance.

Moreover, according to a preferable aspect of the present invention, the distributed processing method further includes a processing-element securing step of securing the processing element for executing the task which forms the service, based on a judgment result of the service-execution judging step.

Moreover, according to a preferable aspect of the present invention, it is preferable that the distributed processing method includes a releasing step of releasing the processing element used in the service, when the processing-element execution step is terminated.

### EFFECT OF THE INVENTION

According to the present invention, there is shown an effect that it is possible to provide a processing system which has a high expendability, and which can be realized at a low cost, and a processing element, a control unit, and a distributed processing method which are used this system

### BRIEF DESCRIPTION OF THE DRAWINGS

FIG. 1A is a diagram showing a schematic structure of a processing element in the present invention;

FIG. 1B is a diagram showing a schematic structure of a control unit according to the present invention;

FIG. 2 is a diagram showing connections of the processing element and the control unit according to the present invention;

FIG. 3 is a diagram showing other connections of the processing element and the control unit according to the present invention;

FIG. 4 is a diagram showing still other connections of the processing element and the control unit according to the present invention;

FIG. 5 is a diagram showing different connections of the processing element and the control unit according to the present invention;

FIG. 6 is a diagram showing a schematic structure of a processing system according to the present invention;

FIG. 7 is a diagram showing a schematic structure of other processing system according to the present invention;

FIG. 8 is a flowchart showing a process of JPEG decoding;

FIG. 9A is a diagram showing a processing model according to a first embodiment;

FIG. 9B is another diagram showing the processing model according to the first embodiment;

FIG. 10 is a diagram showing a structure of a processing-element connection table according to the first embodiment;

FIG. 11 is a diagram showing a structure of a task-execution transition table according to the first embodiment;

FIG. 12 is a diagram showing a structure of a service-task correspondence table according to the first embodiment;

FIG. 13 is a flowchart showing a processing procedure of a control unit according to the first embodiment;

FIG. 14 is a flowchart showing a flow of a process of JPEG decoding according to the first embodiment;

FIG. 15A is another flow chart showing the flow of the process of JPEG decoding according to the first embodiment;

FIG. 15B is another flowchart showing the flow of the process of JPEG decoding according to the first embodiment;

FIG. 16 is still another flowchart snowing the flow of the process of JPEG decoding according to the first embodiment;

FIG. 17 is a different flowchart showing a flow of a process of JPEG decoding according to the first embodiment;

FIG. 18 is a still different flowchart showing a flow of a process of JPEG decoding according to the first embodiment;

FIG. 19 is a flowchart showing a processing procedure of a control unit according to a second embodiment of the present invention;

FIG. 20 is another flowchart showing the processing procedure of the control unit according to the second embodiment; and

FIG. 21 is still another flowchart showing the processing procedure of the control unit according to the second embodiment.

### DESCRIPTION OF REFERENCE NUMERALS

100 processing element
101 processing section
102 data holding section
103 communication section
200 control unit
201 processing section
202 communication section
300 portable terminal
301 mother board
302 system bus
401 mother board
402 I/O board
403 bus for peripherals
501a, 501b LAN
PE0, PE1 etc. processing element
CU1 etc. control units

### BEST MODE FOR CARRYING OUT THE INVENTION

Exemplary embodiments of the present invention will be described below in detail based on the accompanying diagrams. However, the present invention is not restricted by the embodiments described below

### First Embodiment

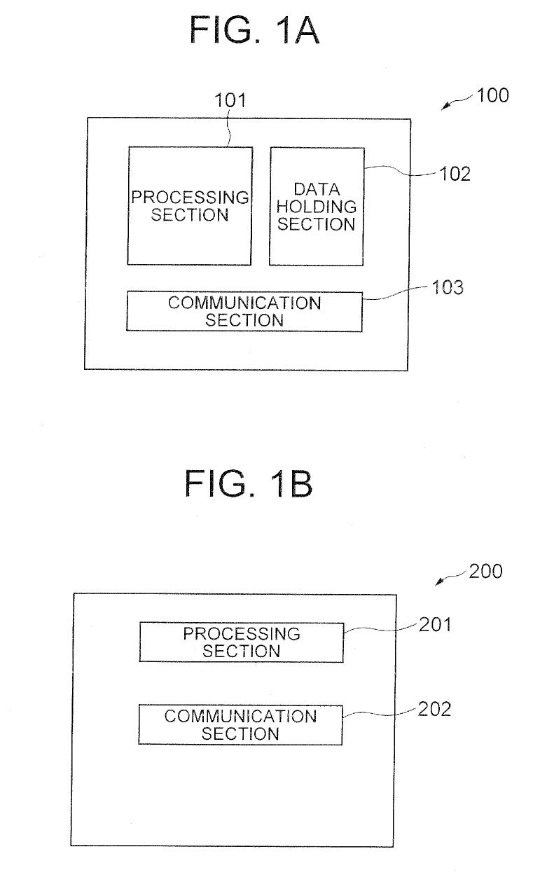

FIG. 1A and FIG. 1B show a schematic structure of a processing element and a control unit respectively according to a first embodiment of the present invention.

In FIG. 1A, a processing element 100 has a processing section 101, a data holding section 102, and a communication section 103. The ‘processing element’ is a constitutional unit of a system that executes one or more than one functions out of four functions namely inputting and outputting, processing, transmission, and storage of data.

The processing section 101 carries out a specific function. The communication section 103 outputs to an outside, function information related to the specific function according to a request from the outside. Furthermore, the data holding section 102 holds the function information.

Here, the processing section 101 may be a function for just letting through data, in other words, just transmitting without processing. Moreover, for the data holding section 102, a rewritable configuration, such as a configuration written as hardware logic, and a configuration of a hexadecimal Dip switch can be used.

For instance, one processing element has a processing function of carrying out one or more than one ‘tasks’, and a data storage function and a data input-output function necessary for this processing. Here, ‘task’ is an executable unit of a certain definite function.

FIG. 1B shows a schematic structure of the control unit 200. The control unit 200 is to have at least a communication section 202. More preferably, the control unit 200 may have a processing section 201. The control unit 200 is formed such that, the processing element 100 having the abovementioned structure can be connected. The control unit, in a distributed processing system of the first embodiment, is a control section which carries out a control of a task-execution transition and assigning of the ‘task’ to each processing element.

The communication section 202 of the control unit 200 outputs function information related to a specific function carried out by a processing element connected to the control unit 200, according to a request from the outside. A detail function of the processing element 100 and the control unit 200 will be described later. ‘Service’ is a set of tasks having one or more than one relationship. The ‘service’ executes processing having a more definite meaning than the ‘task’.

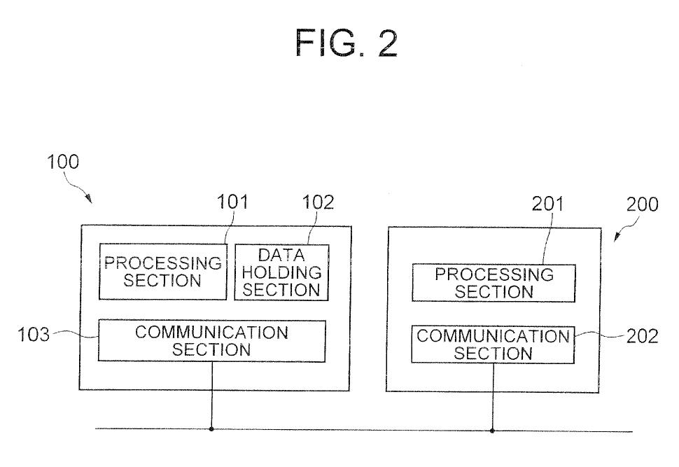

Next, another structure of the processing element and the control unit will be described below. FIG. 2 shows a network configuration using a processing element and a control unit.

One processing element 100 and one control unit 200 are connected via a network. This is an example of the smallest configuration of the network. The processing element 100 and the control unit 200 may be connected by a communication path through which information can be communicated.

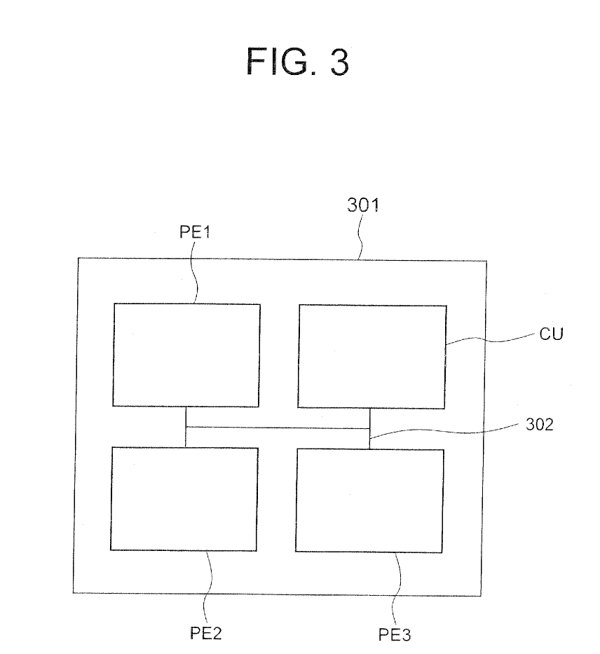

Next, another structure of a processing element and a control unit will be described below FIG. 3 shows an example of another structure. One control unit CU and three processing elements PE1, PE2, and PE3 are mounted on a mother board 301. The control unit CU and the processing elements PE1, PE2, and PE3 are connected by a system bus 302.

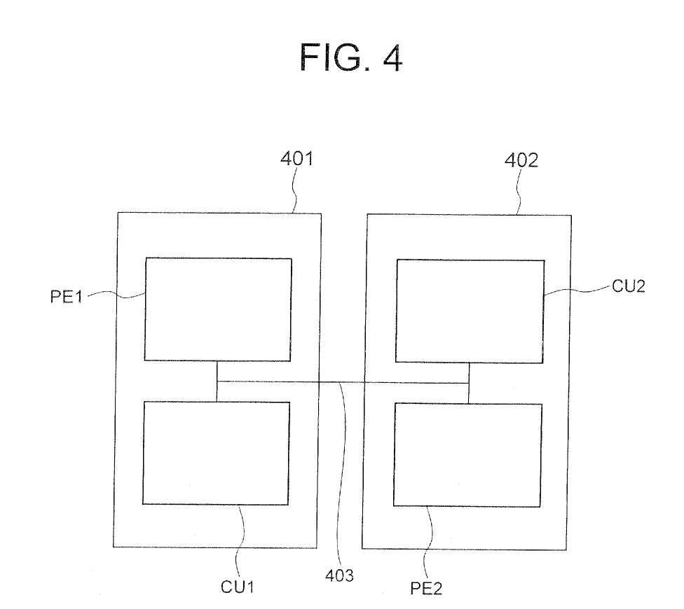

FIG. 4 shows still another structure. A control unit CU1 and a processing element PE1 are mounted on a mother board 401. Moreover, a control unit CU2 and a processing element PE2 are mounted on an I/O board 402. The control units CU1 and CU2 and the processing elements PE1 and PE2 are joined by a bus for peripherals 403. As the bus for peripherals 403, a USB or a PCI bus can be used.

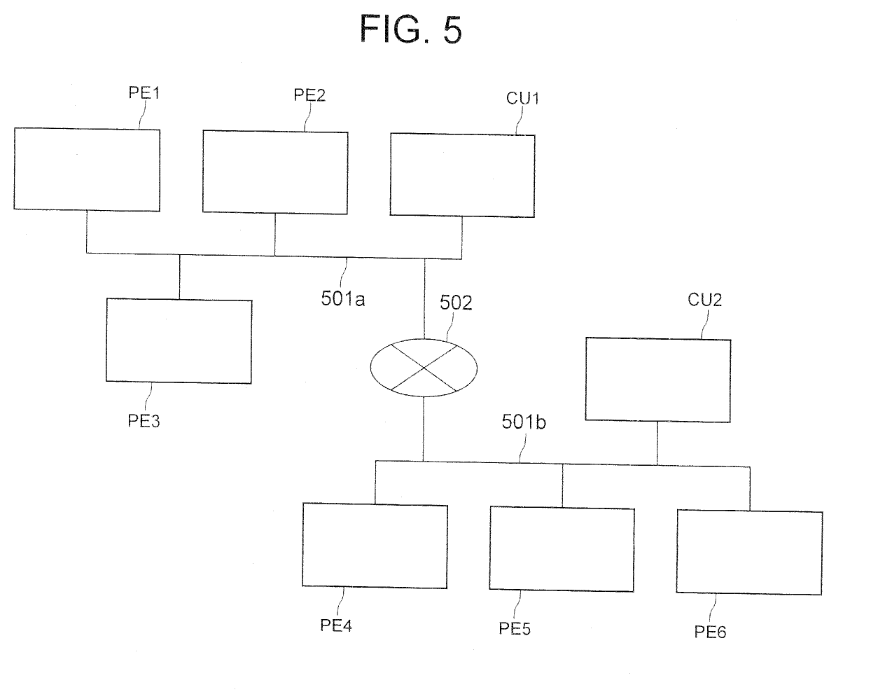

FIG. 5 shows a different structure. Processing elements PE1, PE2, and PE3 and a control unit CU1 are connected to one LAN 501a. Processing elements PE4, PE5, and PE6, and a control unit CU2 are connected to the other LAN 501b. The LAN 501a and the LAN 501b are connected via the internet 502.

In this manner, by combinations of the processing element and the control unit of the present invention, it is possible to include structure from the smallest structure shown in FIGS. 1A and 1B up to a structure of a global scale via the internet shown in FIG. 5.

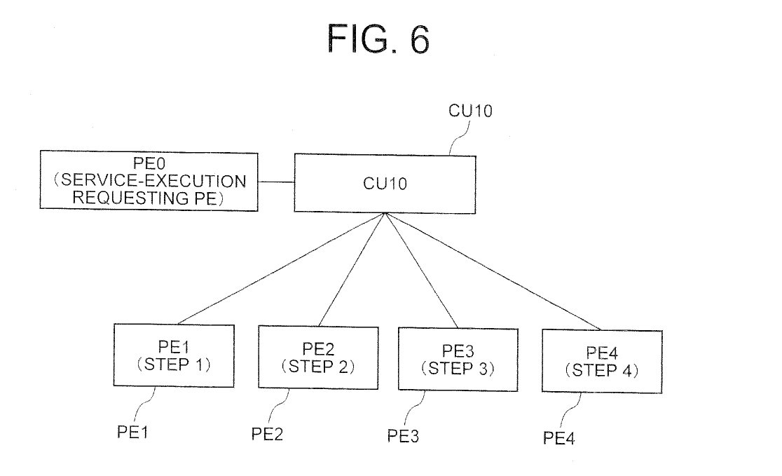

FIG. 6 shows a schematic structure of a distributed processing system of the present invention. Here, a ‘service’ carried out at steps from step 1 to step 4 is taken into consideration. Concretely, ‘step 1’, ‘step 2, ‘step 3’, and ‘step 4’ correspond to a task. Moreover, a set of a series of processes at steps from step 1 to step 4 corresponds to the ‘service’.

So far, regarding path information on the internet, it is not that a specific computer has information of all computers connected to the internet. A path control terminal called as router, controls only information of a sub network and information of an adjacent network. Moreover, the system is such that information necessary is inquired to the adjacent network according to the requirement.

In the first embodiment, a control unit (corresponds to a router) which controls only sub network information of the processing element and sub network information of the adjacent sub network is provided. Some of the processing elements on the network are connected to the control unit.

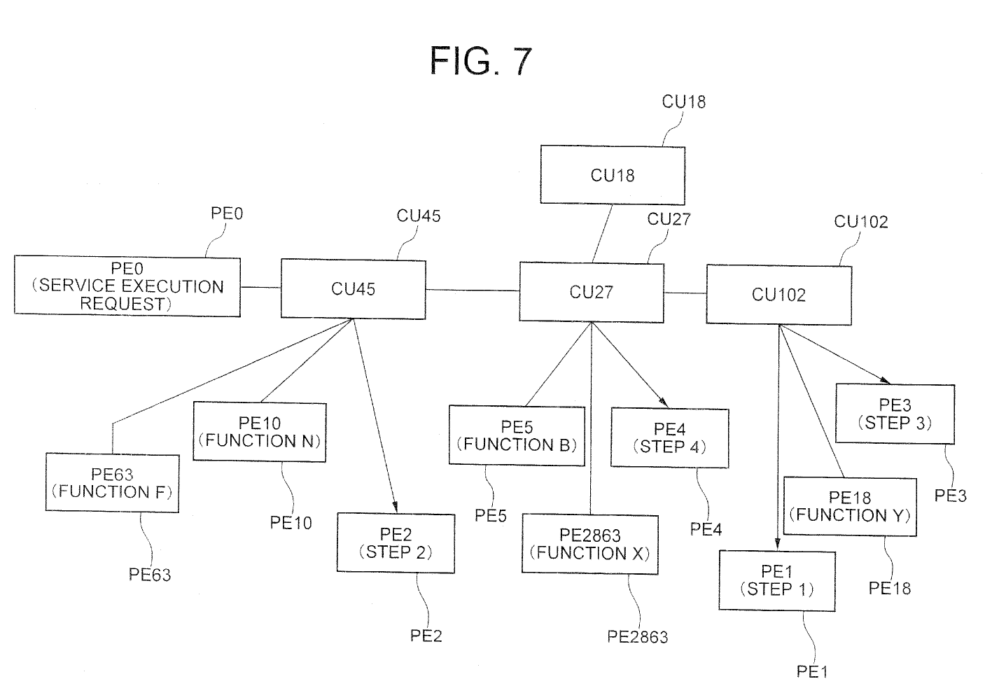

Next, a schematic structure of the present invention will be described below based on FIG. 6 and FIG. 7. Detail contents such as a procedure and a structure will be described later.

(Processing in a Single Network)

In FIG. 6, four processing elements PE1, PE2, PE3, and PE4 are connected to a control unit CU10. A task-execution processing element PE0 outputs an execution request of a service.

Here, for executing the service, a case in which, the processing element PE1 of a function which carrying out ‘step 1’, the processing element PE2 of a function which carries out ‘step 2’, the processing element PE3 of a function which carries out ‘step 3’, and the processing element PE4 of a function which carries out ‘step 4’ are necessary is taken into consideration.

Here, all the necessary processing elements P1 to P4 are connected to the control unit CU10. The control unit CU10 identifies each processing element connected, and a function thereof.

Moreover, steps from step 1 to step 4 can be executed by the processing elements PE1 to PE4 connected to the control unit CU10. In this manner, FIG. 6 shows a case in which a specific service can be executed in the single network.

(Processing Spread Over Plurality of Networks)

Furthermore, an outline of a case of carrying out a processing spread over a plurality of networks will be described by using FIG. 7. A processing element PE1 for executing step 1 is connected to a control unit CU102. A processing element PE2 for executing step 2 is connected to a control unit CU45.

A processing element PE3 for executing step 3 is connected to the control unit 102. Further, a processing element PE4 for executing step 4 is connected to a control unit CU27.

The processing element PE0 (client processing element) makes a service request to the control unit CU45 to which it is connected. The control unit CU45 retrieves a processing element suitable for processing content. Further, the control unit CU45 assembles a processing procedure (routing procedure). When data is input from a server etc., the control unit CU45 carries out a processing according to the routing procedure, and returns a processing result to the processing element PE0. Accordingly, it is possible to carry out steps from step 1 to step 4. A detail procedure will be described later

Here, the processing elements may be connected by any of the following methods. A connection method is not restricted to a wired connection, and it may be a wireless connection.

(1) Network cable (such as Ethernet (registered trademark), InfiniBand, and Myrinet)
(2) Processor internal bus (such as AMBA and hyper transport)
(3) Bus for peripheral connections (such as USB and PCI)

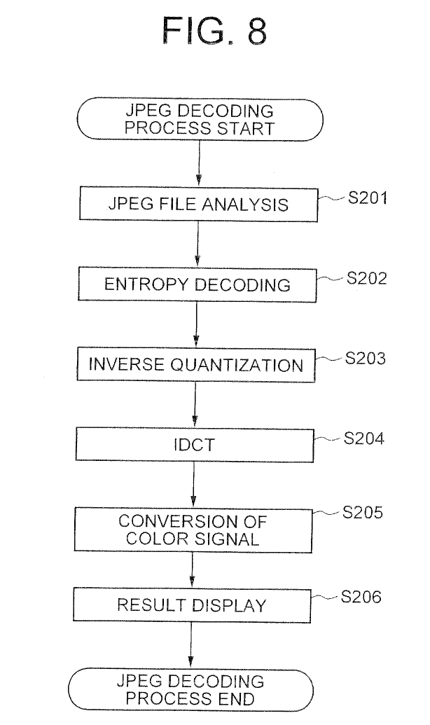

Next, the first embodiment will be described below by using a concrete example. Here, a case of carrying out JPEG decoding is considered. FIG. 8 is a flowchart showing a processing procedure carrying out JPEG decoding.

At step S201 in FIG. 8, an analysis of a JPEG file is carried out. At step S202, an entropy decoding is carried out. At step S203, an inverse quantization is carried out. At step S204, an IDCT (Inverse Discrete Cosine Transform) is carried out. At step S205, a conversion of a color signal is carried out. At step S206, a result display is carried out. And a decoding process of JPEG (JPEG decoding process) is over.

As it has been mentioned above, ‘task’ is an executable unit of a certain definite function. In an example of JPEG decoding shown in FIG. 8, each step of JPEG decoding is formed of a task. For example, ‘quantization’ is one task. Each task is assigned an identification number called as a task identifier (hereinafter called appropriately as ‘TID’). A function that task executes and the TID, correspond one-on-one.

Moreover, ‘service’, as it has been described above, is a set of tasks having one or more than one relationships. JPEG decoding process is an example of a service. A unique identification number called as a service identifier (hereinafter called appropriately as ‘SID’) is assigned to a service.

Moreover, a process element which requests an execution of a service is called particularly as service-execution requesting processing element.

There is also a case in which one task becomes one service. For instance, in the example of JPEG decoding, when a processing of IDCT is requested as a service, a result upon carrying out the IDCT processing is returned with respect to an input.

Furthermore, the service-execution requesting processing element is not required to receive result data. There are also cases in which, display, storage etc. of data is carried out by the other processing element, and service is terminated.

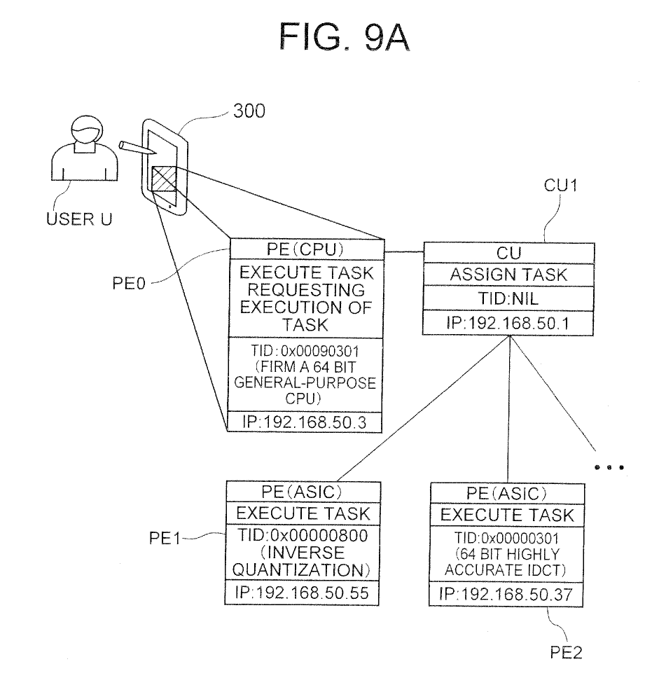

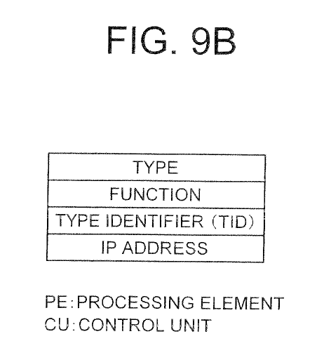

FIG. 9A shows an outline of a processing model. The processing model is formed of one control unit CU1, one service-execution requesting processing element PE0, and two or more task-process processing elements including the PE1 and PE2. The service-execution requesting processing element PE0 can function also as a task-execution processing element.

FIG. 9B shows a configuration of information held by the processing elements PE0, PE1, and PE2 (hereinafter appropriately called as ‘processing elements such as PE0’ and the control unit CU1. In FIG. 9B, ‘type’ indicates distinction between control unit and processing element. ‘Function’ indicates ‘executing a task’, ‘assigning a task’, and ‘requesting an execution of a task’ etc. A task identifier is assigned to ‘quantization’, ‘64 bit highly accurate IDCT’ etc.

Next, an outline of a data structure used in the processing system of the present invention will be described below.

(Processing-Element Connection Table)

The control unit CU1, upon detecting a connection of the processing element such as PE0, inquires information of that processing element such as PE0 to this processing element PE0. Further, the control unit CUE acquires information of the processing element such as PE0, and prepares a list for controlling the processing element such as PE0 which is connected to the control unit CU1. This is called as a processing-element connection table.

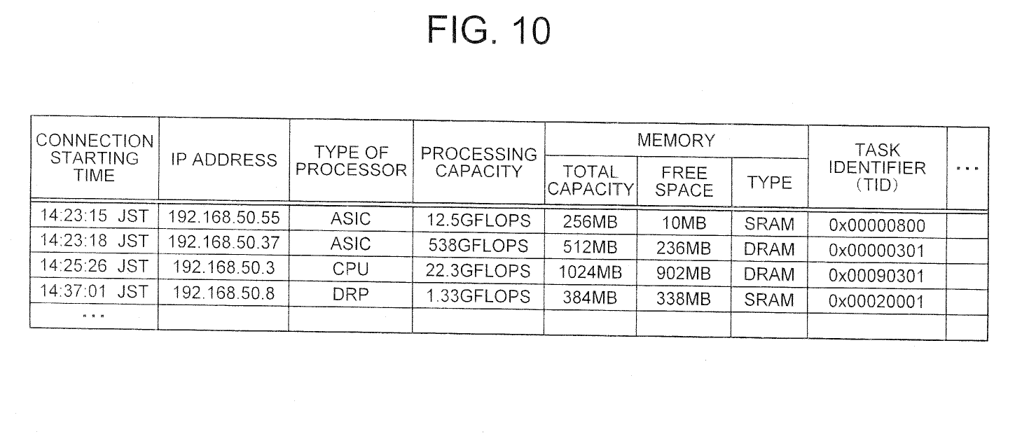

In a processing-element connection table shown in FIG. 10, information such as ‘connection starting time’, ‘IP address’, ‘type of processor’, ‘processing capacity’, ‘memory’, and ‘task identifier’ is described. Timing for creating the Processing-element connection table will be described later.

(Task-Execution Transition Table)

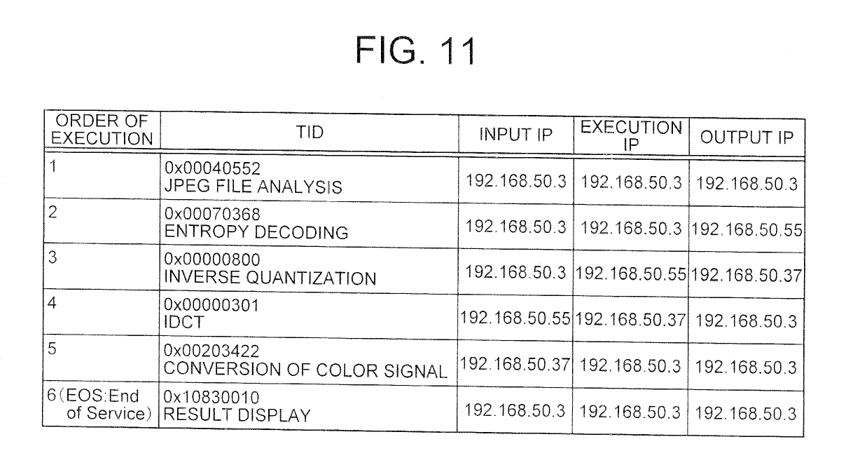

A task-execution transition table shown in FIG. 11 is a list in which, the processing elements such as PE0 which carry out input and output, IP addresses of the processing elements such as PE0 which execute the task, and the task identifiers are arranged in an order of execution. The control unit CU1 assigns task to the processing element such as PE0 based on the task-execution transition table.

‘Task identifiers (TID)’, ‘input IPs’, ‘execution IPs’, and ‘output IPs’ are described in an execution order in the task-execution transition table.

(Task-Execution Request)

For requesting an execution of a task assigned to the processing element such as PE0, information described in each line of the task-execution transition described above, that is, the execution order, the TID, the input IP, the execution IP, and the output IP are transmitted to the respective processing elements such as PE0 from the control unit CU1 as a task-execution request.

The processing element which executes number one task in the execution order, upon receiving the task-execution request, starts the execution of the task. The other processing element waits till the execution of the processing element which carries out the task execution immediately before that other processing element.

(Task-Execution Completion and Service-Execution Completion)

A processing element which executes a task corresponding to a completion of a service transmits a task-execution completion to the control unit CU1 when the execution of the task is completed. Upon receiving the task-execution completion, the control unit CU1 transmits to the service-execution requesting processing element PE0 a message that the execution of the service is completed, and once again assumes a stand-by state for a request.

(Service-Task Correspondence Table)

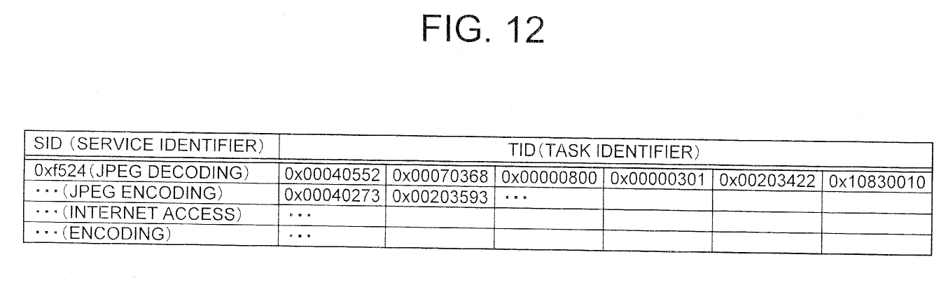

A service-task correspondence table is a table in which, a correspondence of services and tasks forming the services is listed up by using identifiers. FIG. 12 shows an outline of the service-task correspondence table. The control unit CU1, at the time of initialization of the control unit CU1, is acquired from a server which controls the service-task correspondence table.

Service identifiers (SID) and task identifiers (TIC) are described in the service-task correspondence table.

(Process Flow of Control Unit)

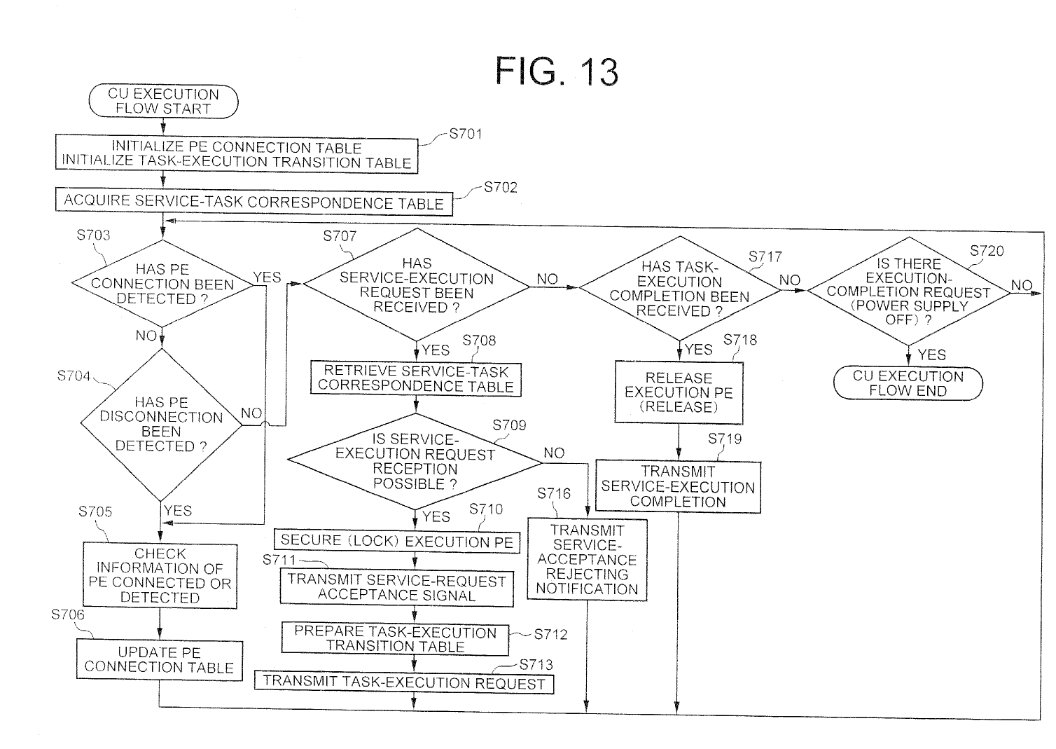

FIG. 13 is a flowchart showing a processing procedure of the control unit CU1. The control unit CU1 carries out the following processes (1), (2), (3), and (4) according to a procedure of the flowchart shown in FIG. 13.

(1) Detection of connection or disconnection of a processing element,
(2) Reception and response of (receiving and rejecting) service-execution request, transmission of task-execution request,
(3) Task-execution completion reception and service-execution completion transmission
(4) Securing (locking) and releasing processing-element source (resource).

At step S701, the control unit CU1 initializes the processing-element connection table by putting the power supply ON for example. Moreover, the control unit CU1 initializes the task-execution transition table.

At step S702, the control unit CU1 acquires the service-task correspondence table from the server which controls the service-task correspondence table.

At step S703, the control unit CU1 makes a judgment of whether or not the connection of the processing element such as PE0 is detected. When a judgment result at step S703 is negative (No), the process advances to step S704. When the judgment result at step S703 is affirmative (Yes), the process advances to step S705.

At step S704, a judgment of whether or not the processing element such as PE0 has been disconnected is made. When a judgment result at step S704 is affirmative (Yes), the process advances to step S705. Moreover, also when the judgment result at step 703 is affirmative, the process advances to step S705.

At step S705, the control unit CU1 checks information, particularly function information, of the processing element such as PE0 which is connected or disconnected. And then, at step S706, (the control unit CU1) updates the processing-element connection table. Next, the process returns to step S703.

When the judgment result at step S704 is negative, the process advances to step S707. At step S707, the control unit CU1 makes a judgment of whether or not the service-execution request is received from the service-execution requesting processing element PE0. When a judgment result at step S707 is affirmative, the process advances to step S708.

At step S708, the control unit CU1 retrieves the service-task correspondence table. Next, at step S709, (the control unit CU1) makes a judgment of whether or not the service-execution request can be received (can be accepted). When a judgment result at step S709 is affirmative, the process advances to step S710.

A procedure at step S708 is not restricted to a case of retrieving the service-task correspondence table. For instance, only knowing as to what the task which forms the service is, is sufficient. Here, the data structure is not required to be a table. Moreover, there are cases in which, retrieving the service-task correspondence table is not necessary. For instance, it is a case in which, information of a task forming the service is acquired together at the time of service request, in advance.

At step S710, (the control unit CU1) secures (locks) the processing element such as PE0 necessary for executing the processing of JPEG decoding. At step S711, the control unit CU1 transmits a signal of the service-request receiving to the service-execution requesting processing element PE0. At step S712, the control unit CU1 creates the task-execution transition table described above. At step S713, the control unit CU1 transmits the request of (for) task execution to each processing element such as PE0 which executes the task.

At step S712, regarding the task-execution transition, it is favorable that information can be acquired. For this, it is not necessarily restricted to a case of creating the task-execution transition table. For instance, it is a case in which, the data structure is such that the execution order is also known simultaneously when the task information which forms the service is acquired.

When a judgment result at step S709 is negative, the process advances to step S716. At step S716, the control unit CU1 being incapable of receiving the service, transmits service-acceptance rejecting notification to the service-execution requesting processing element PE0. Next, the process returns to step S703.

When the judgment result at step S707 is negative, the process advances to step S717. At step S717, the control unit CU1 makes a judgment of whether or not the task-execution completion is received from each processing element such as PE0 which executes the task. When a judgment result at step S717 is affirmative, the process advances to step S718.

At step S718, the control unit CU1 releases the processing element such as PE0 which has executed the task. At step S719, the control unit CU1 transmits a message that the service execution is completed, to the service-execution requesting processing element PE0. Next, the process returns to step S703.

When the judgment result at step S717 is negative, the process advances to step S720. At step S720, the control unit CU1 makes a judgment of whether or not there is an execution-completion request, such as, whether the power supply has been put OFF. When a judgment result at step S720 is affirmative, the execution process of the control unit CU1 is over. When the judgment at step S720 is negative, the process returns to step S703. In this procedure, the processing-element connection table corresponds to processing-element connection information. The task-execution transition table corresponds to task-execution transition information. The service-task correspondence table corresponds to service-task correspondence information. The task-execution transition table corresponds to the task-execution transition information. The data structure when each processing element such as PE0 holds the information may be any structure.

(Example of JPEG Decoding Process)

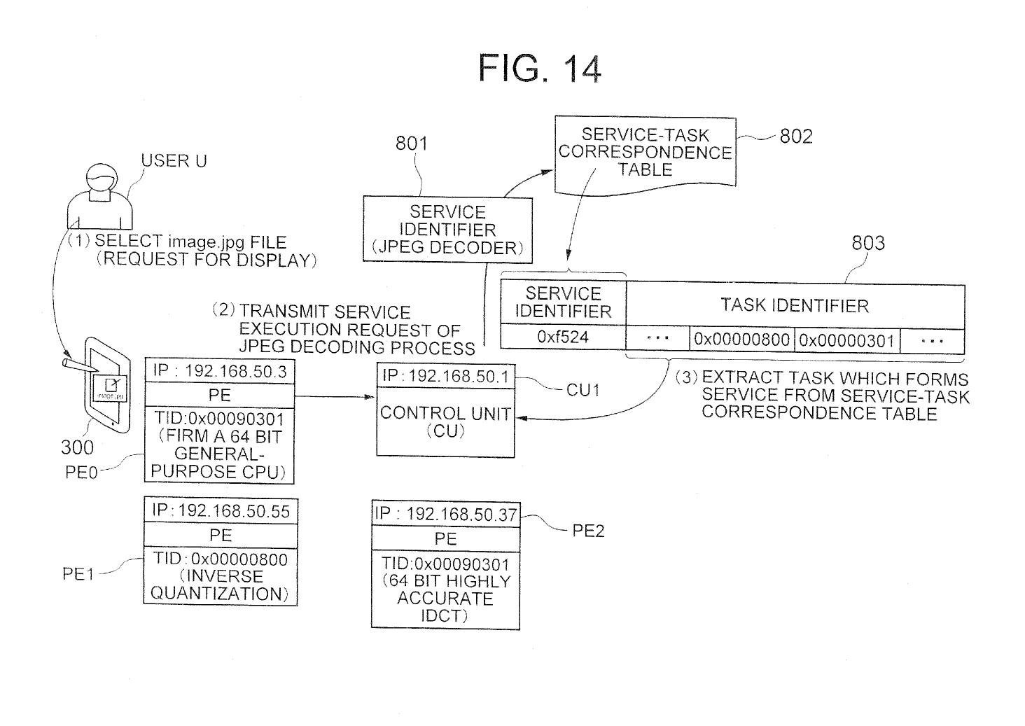

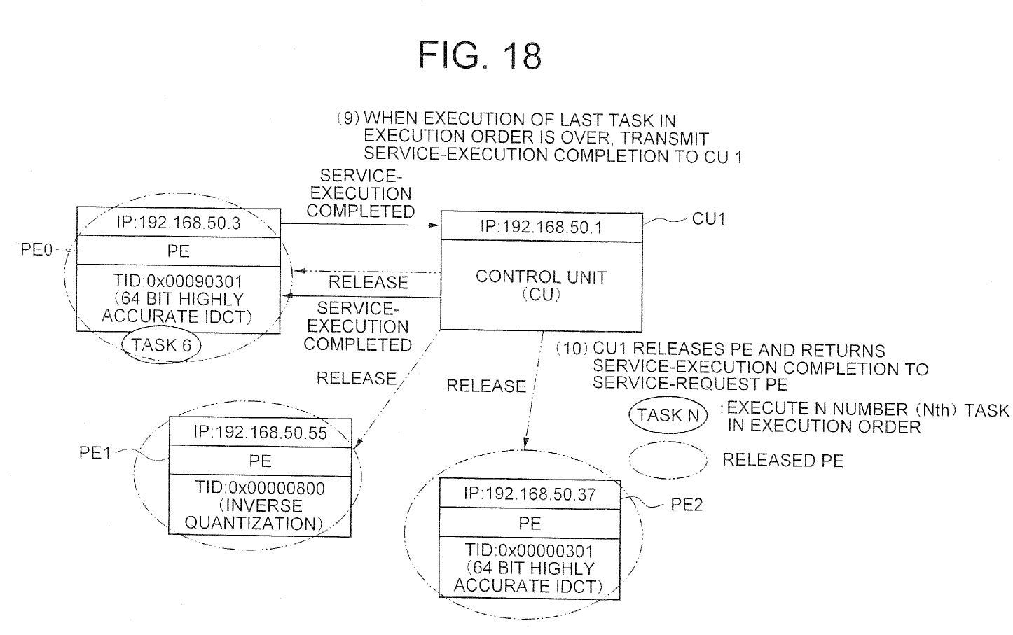

Next, a flow of the JPEG decoding process in a processing model shown in FIG. 8 will be described according to a time series, based on diagrams from FIG. 14 to FIG. 18. In this example, a case in which, a user U displays a JPEG image called as ‘image.jpg’ on a portable terminal 300 is taken into consideration. When the user U specifies a file, JPEG decoding is subjected to distributed processing on a processing-element network, and a result is displayed on the portable terminal 300.

(Preconditions)

In the following description, contents of the following (a) to (d) are let to be preconditions.

(a) The control unit CU1 has completed the necessary initialization process.
(b) The connection of the processing element is detected, and the processing-element connection table has already been updated.
(c) The service-task correspondence table has already been acquired.
(d) The control unit CU1 is aware that all processes except the ‘IDCT’ and ‘inverse quantization’ are executable in the processing element PE0 mounted on the portable terminal, by some method.

In FIG. 14, first of all, (1) the user U makes a request for a JPEG file by double clicking an icon of ‘image.jpg file’ on the portable terminal or the like.

(2) The portable terminal makes a judgment that the decoding process of the JPEG file is necessary. Accordingly, the portable terminal sends a service-execution request for JPEG decoding process, to the control unit CU1.

(3) The control unit CU1, upon receiving the service-execution request, refers to a service-task correspondence table 802 based on a service identifier (ID) 801 indicating JPEG decoding. Further, the control unit CU1 acquires a task necessary for the service, and an execution order 803 thereof from the service identifier 801.

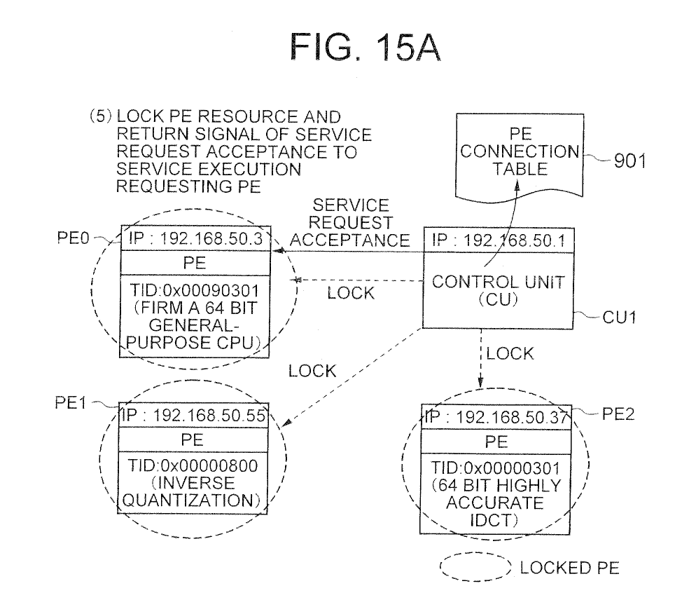

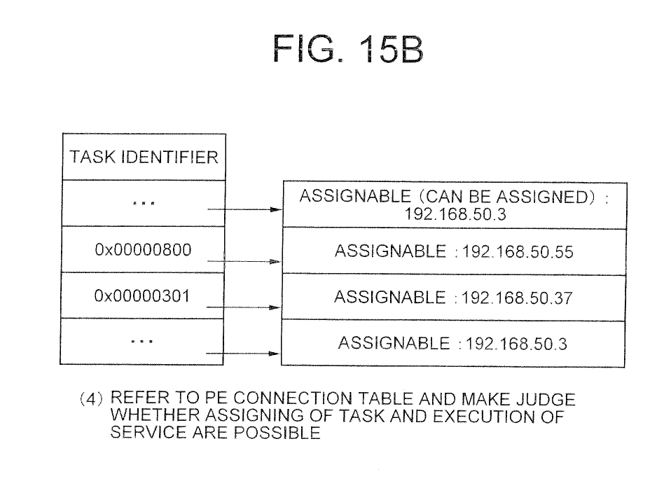

In FIG. 15A, the control unit CU1 refers to a processing-element (PE) connection table 901. Further, as shown in FIG. 15B, (4) by using the processing element such as PE0 connected to the control unit CU1, the control unit CU1 makes a judgment of whether or not an execution of the service requested is possible.

(5) The control unit CU1, when a judgment that the execution of the service is possible is made, secures (locks) a necessary processing-element source (resource). Accordingly, a computing source (resource) for only executing the service can be secured. Furthermore, (the control unit CU1) transmits a signal of the service-request acceptance (reception) to the service-execution requesting processing element PE0.

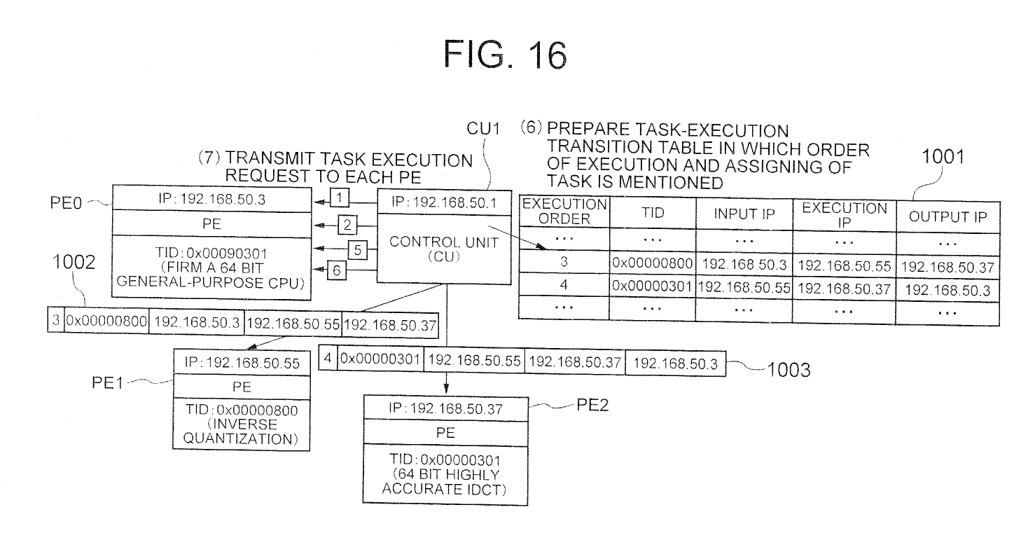

As shown in FIG. 16, (6) the control unit CU1 creates a task-execution transition table 1001 in which an execution order and assigning of the processing element such as PE0 which executes each task is mentioned.

(7) The control unit CU1, according to task assignment of the task-execution transition table, transmits the task-execution request in order of a processing element later in the execution order to a processing element earlier in the execution order. Here, when an IP address of a processing element such as PE0 which inputs or outputs data, and an IP address of a processing element which executes are same, a task execution inside the processing element is awaited, and the task is let to be executed continuously inside the same processing elements.

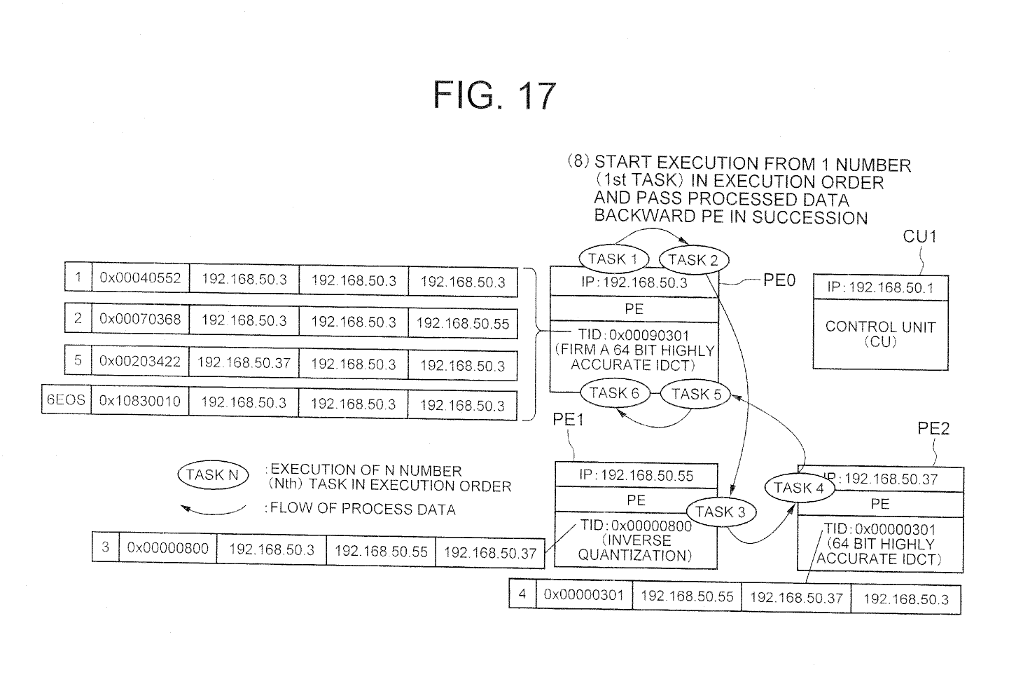

As shown in FIG. 17, (8) the processing element PE0 which has received the first task-execution request in the execution order starts execution of the task, and transmits an execution result to the subsequent processing element PE1 specified by an output-destination IP address.

Further, as shown in FIG. 15, (9) when the last task execution in the execution order is carried cut by a processing element PE6 for example, the processing element PE6 (not shown in the diagram) transmits the task-execution completion to the control unit CU1.

(10) The control unit CU1, upon receiving the task-execution completion, releases the processing element source which has been secured (locked). Accordingly, a state in which the other service can be used is returned. Further, the control unit CU1 returns the service-execution completion to the service-execution requesting processing element PE0. (11) The control unit CU1 waits till receiving the subsequent service-execution request.

### Second Embodiment

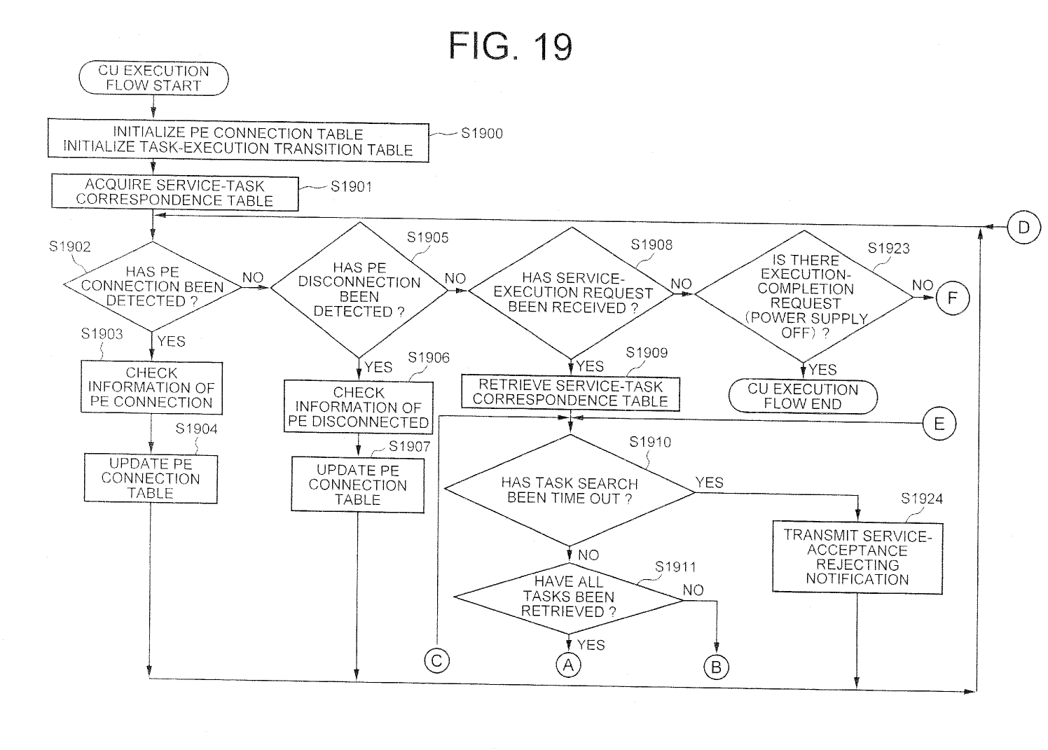

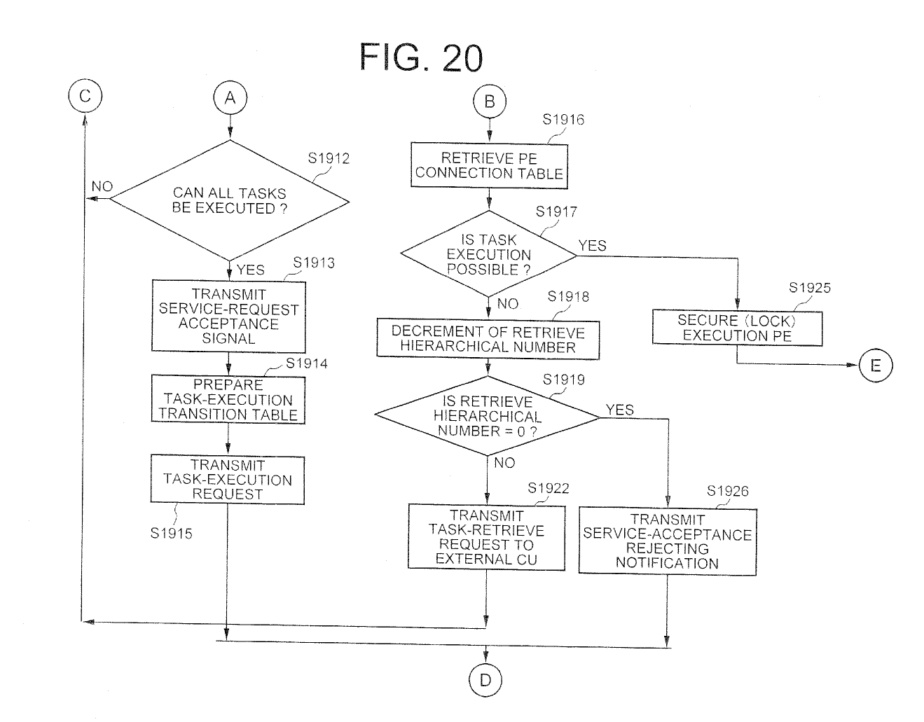

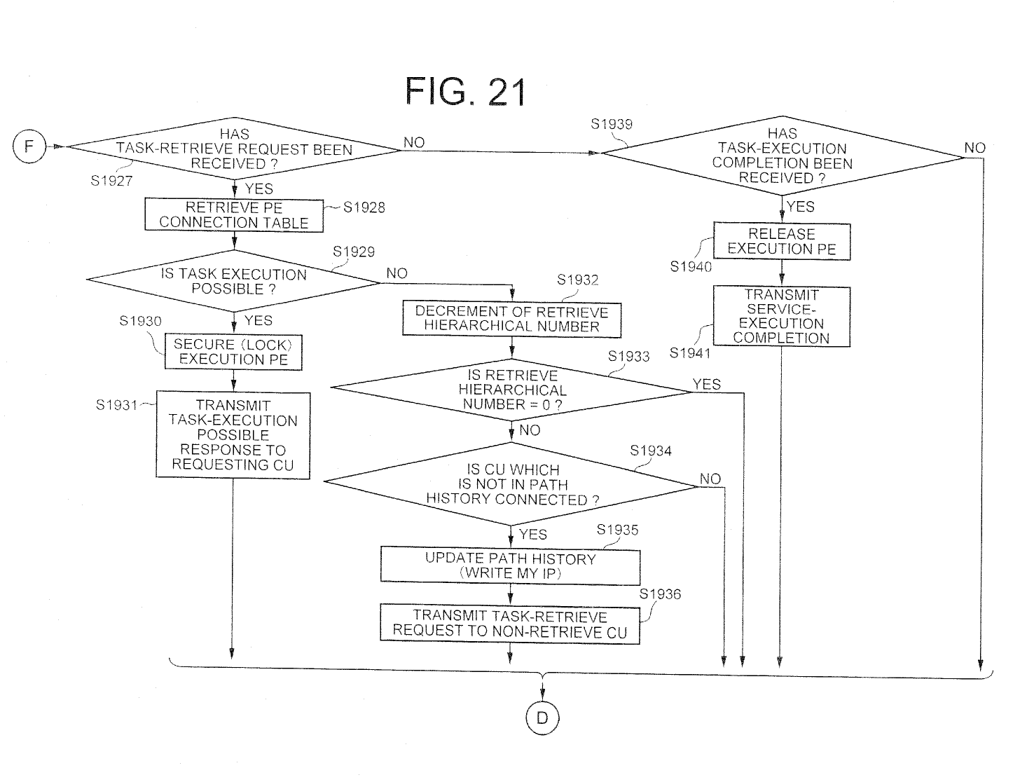

Next, a distributed processing method according to a second embodiment of the present invention will be described below. FIG. 19, FIG. 20, and FIG. 21 are flowcharts showing a procedure of the distributed processing method according to the second embodiment.

At step S1900, the control unit CU1 initializes the processing-element connection table mentioned above. At this time, the control unit CU1 also acquires information of a processing-element connection table of a control unit in a predetermined hierarchy (for example, hierarchy number=1). A concept of hierarchy will be described later. Moreover, the control unit CU1 initializes the task-execution transition table.

A hierarchy is an indication of a communication distance of information from own control unit reaching up to the other control unit. The communication distance may be defined by an arbitrary index, but it is most common to indicate the communication distance by time (response speed) till the information reaches. Apart from a classifying according to a response speed, it is also possible to classify by as to whether or not within a communication range, for example, in a sub network to which one belongs when a network according to the control unit is taken into consideration.

Task assignment or service retrieval is carried out in order of a control unit having a hierarchy number 0 to a control unit having a hierarch number higher. When conditions applicable are in plurality, the smallest hierarchy number is assigned.

(Examples of Hierarchical Values of Classification According to Response Speed)

Own control unit: 0
Two control units of the fastest response speed: 1
Control unit of the response speed not higher (more) than 50 ms: 2
Control unit of the response speed not higher (more) than 200 ms: 3
Other control units: 4

(Examples of Hierarchical Values of Classification According to Communication Range)

Own control unit: 0
Control unit in the same sub network: 1
Other control units: 2

Moreover, the hierarchy number may be determined by combining these. In this case, for example, it is expressed by a sum of the hierarchy numbers determined by two classifications. For a control unit in the same sub network, and having the fastest response speed, it becomes 1+1=2.

At step S1901, the control unit CU1 acquires the service-task correspondence table from a server that controls the service-task correspondence table.

At step S1902, the control unit CU1 makes a judgment of whether or not the connection of the processing element such as PE0 is detected. When a judgment result at step S1902 is affirmative (Yes), the process advances to step S1903.

At step S1903, the control unit CU1 checks information, particularly function information, of the processing element such as PE0 that is connected. At step S1904, the control unit CU1 updates the processing-element connection table. At this time, the control unit CU1 transmits information of the connection update to a control unit within a predetermined hierarchy (for example, hierarchy number=1) when the connection of the processing element connected to that control unit CU1 has changed. Next, the process returns to step S1902. The predetermined hierarchy number mentioned above can be set freely.

When the judgment result at step S1902 is negative, the process advances to step S1905. At step S1905, the control unit CU1 makes a judgment of whether or not the processing element such as PE0 is disconnected. When a judgment result at step S1905 is affirmative (Yes), the process advances to step S1906.

At step S1906, the control unit CU1 checks information, particularly function information, of the processing element such as PE0 that is disconnected. Further, at step S1907, the control unit CU1 updates the processing-element connect-on table. At this time, even for the processing element that is disconnected, the control unit CU1 transmits information of the connection update to a control unit within a predetermined hierarchy (for example, hierarchy number=1), when the connection of the processing element connected to that control unit CU1 has changed. Further, the process returns to step S1902.

When the judgment result at step S1905 is negative, the process advances to step S1908. At step S1908, the control unit CU1 makes a judgment of whether or not the service-execution request is received from the service-execution requesting processing element such as PE0. When a judgment result at step S1908 is affirmative, the process advances to step S1909.

At step S1909, the control unit CU1 retrieves the service-task correspondence table. Next, at step S1910, the control unit CU1 makes a judgment of whether or not the task retrieval is time out.

Here, the ‘task retrieval’ is retrieving a processing element for which, a task process is possible. Firstly, a judgment of whether or not assigning the task process to the processing element such as PE0 connected to own control unit CU1 is possible is made. When assigning of the process of the task to the processing element such as PE0 connected to own processing unit CU1 is not possible, it is retrieved whether the processing element for which the task process is possible is connected. Concretely, task-retrieve request is transmitted to the other control unit.

Moreover, ‘time out’ is a time limit for the process. For instance, it is possible to provide two types of time out namely, (1) time out for a task which is being executed, and (2) time out for task retrieve to the other control unit.

When a judgment result at step S1910 is negative, the process advances to step S1911. At step S1911, a judgment of whether or not all the tasks which form the service have been retrieved is made. When a judgment result at step S1911 is affirmative, the process advances to step S1912. At step S1912, a judgment of whether or not all the tasks are executable is made. In the second embodiment, in the processing-element connection table of the control unit CU1, a connection table within a predetermined hierarchy is further included in addition to the connection table of the processing elements connected to the control unit CU1. In other words, in the second embodiment, a processing-element connection table related to a control unit adjacent to the control unit CU1 is included. The processing-element connection table is initialized and updated at steps S1900, S1904, and S1907, and hold a connection table of the latest retrieve hierarchy number=1. Hereinafter, the connection table ‘retrieve hierarchy number=1’ is let to be included appropriately in the ‘processing-element (PE) connect on table’.

When a judgment result at step S1912 is affirmative, the process advances to step S1913. At step S1913, the control unit CU1 transmits a signal of service-request acceptance to the service-requesting processing element. At step S1914, the control unit CU1 creates the task-execution transition table mentioned above. At step S1915, the control unit CU1 transmits a request for task execution Next, the process returns to step S1902.

Moreover, when the judgment result at step S1912 is negative, the process returns to step S1910.

When the judgment result at step S1908 is negative, at step S1923, the control unit CU1 makes a judgment of whether or not there has been an execution-completion request, such as whether or not the power supply has been put OFF. When a judgment result at step S1923 is affirmative, the execution process of the control unit CU1 is terminated. When the judgment result at step S1923 is negative, the process advances to step S1927.

Moreover, when the judgment result at step S1910 is affirmative, the process advances to step S1924. At step S1924, the control unit CU1, being incapable of accepting a service, transmits the service-acceptance rejecting notification to the service-requesting PE. Next, the process returns to step S1902.

As it has been mentioned above, when the judgment result at step S1911 is negative, the process advances to step S1916. At step S1916, the control unit CU1 retrieves the processing-element connection table mentioned above.

At step S1917, the control unit CU1 makes a judgment of whether or not the execution of task is possible. When a judgment result at step S1917 is negative, the process advances to step S1918.

At step S1918, the control unit CU1 reduces (decrements) a retrieve hierarchy number. The ‘retrieve hierarchy number’ is synonymous with the hierarchy number determined by the communication distance described above, and is sum total of the hierarchy numbers required at the time of task retrieve. Here, the retrieve hierarchy number is restricted (limited). Accordingly, a setting is made such that when the retrieve hierarchy number reaches an upper limit by retrieve, the retrieve is terminated. For example, when from the control unit CU1 up to the control unit CU2, from the control unit CU2 up to the control unit CU3 the hierarchy number is 1 in each case, a path (from) control unit CU1→control unit CU2→control unit CU3 has the retrieve hierarchy number=2.

At step S1919, a judgment of whether or not the retrieve hierarchy number=0 is made. When a judgment result as step S1919 is negative, the process advances to step S1922.

At step S1922, the control unit CU1 transmits a task-retrieve request to an external control unit. Next, the process returns to step S1910. Here, the external control unit means a control unit which has the retrieve hierarchy numbers larger than a predetermined retrieve hierarchy numbers, and indicates two or more in the second embodiment.

When the judgment result at step S1917 is affirmative, at step S1925, for instance, in the abovementioned example, the processing-element such as PE0 necessary for executing the process of JPEG decoding is secured (locked).

At step S1919, when the judgment result is affirmative, at step S1926, the control unit CU1 cannot accept a service. This is because, when the upper limit of the retrieve hierarchy number is 1, it reaches the upper limit of the retrieve hierarchy number only by retrieving the processing-element (PE) connection table. Consequently, the control unit CU1 transmits the service-acceptance rejecting notification to the service-requesting PE. Next, the process returns to step S1902.

Furthermore, a description when a judgment result at step S1923 is negative will be continued. At this time, the process advances to step S1927. At step S1927, a judgment of whether or not a request for the task retrieve has been received is made.

When a judgment result at step S1927 is affirmative, at step S1928, the control unit CU1 retrieves the processing-element connection table.

At step S1929, a judgment of whether or not the execution of the task is possible is made. When a judgment result at step S1929 is affirmative, at step S1930, for instance, in the abovementioned example, the processing element necessary for executing the process of JPEG decoding is secured (locked).

At step S1931, the control unit CU1 transmits a response that the task execution is possible, to the requesting control unit. Next, the process returns to step S1902.

When the judgment result at step S1929 is negative, at step S1922, the retrieve hierarchy number is reduced (decrement). Next, the process advances to step S1933.

At step S1933, a judgment of whether or not the retrieve hierarchy number=0 is made. When a judgment result at step S1933 is negative, the process advances to step S1934. At step S1934, a judgment of whether or not a control unit which does not exist in a path (route) history is connected is made.

When a judgment result at step S1934 is affirmative, at step S1935, the control unit CU1 updates the path history. The updating of the path history is writing an IP address of control unit CU1 itself.

At step S1936, the control unit CU1 transmits a task-retrieve request to a control unit which is not retrieved. Next, the process returns to step S1902.

When the judgment result at step S1933 is affirmative, the upper limit of the retrieve hierarchy number being reached, the retrieve is discontinued. Moreover, when the judgment result at step S1934 is negative, a judgment is made that all the control units CU have been retrieved, and the retrieve is discontinued. Further, in any of the cases, the process returns to step S1902.

A description when the judgment result at step S1927 is negative will be continued. At this time, the process advances to step S1939. At step S1939, the control unit CU1 makes a judgment of whether or not the task-execution completion has been received. When a judgment result at step S1939 is affirmative, the process advances to step S1940.

At step S1940, the control unit CU1 releases the processing element such as PE0 which has executed the task. At step S1941, the control unit CU1 transmits (a message) that the service execution has been completed, to the service-requesting PE. Next, the process returns to step S1902.

When the judgment result at step S1939 is negative, the process returns to step S1902.

For a function execution method of the processing element in the present invention, a hardware accelerator and software in a general-purpose processor can be used. Moreover, it may be a so-called reconfigurable processor which is capable of reconfiguring dynamically a configuration of the hardware. Furthermore, path information in the software and the reconfigurable processor is information which includes a case of downloading dynamically at the time of execution.

### INDUSTRIAL APPLICABILITY

As it has been described above, the processing system of the present invention is useful particularly in a distributed processing system.

1. A processing element comprising:
a processing section which carries out a specific function;
a communication section which outputs to an outside, function information related to the specific function according to a request form the outside; and
a data holding section which holds the function information.

2. A control unit which is connected to a processing element, comprising:
a communication section which outputs function information related to a specific function which is carried out by the processing element to which the processing element is connected, according to a request from an outside.

3. The control unit according to claim 2, wherein the communication section can inquire to another control unit, about function information of the processing element connected to the other control unit.

4. The control unit according to claim 2, wherein the control unit detects the processing element connected to or disconnected from the control unit.

5. A processing system comprising:
a processing element; and
a control unit, wherein:
the processing element includes:
a processing section which carries out a specific function,
a communication section which outputs to an outside, function information related to the specific function according to a request from the outside, and
a data holding section which holds the function information, and
the control unit has a communication section which outputs the function information of the processing element connected, according to a request from the outside.

6. The processing system according to claim 5, wherein the control unit has a data holding section which acquires via the communication section the function information of the processing element connected to the control unit, and holds the function information acquired.

7. The processing system according to claim 6, wherein:
the control unit:
detects the processing element that is connected or disconnected, and
creates or updates processing-element connection information for controlling at least the function information of the processing element which is connected to the control unit, and
receives an execution request related to a specific service, and
acquires information of a task which forms the service, and
makes a judgment about an execution of the service by using the processing element which is connected to the control unit, by referring to the processing-element connection information, and
acquires a task-execution transition information for executing the task which forms the service, based on a judgment result about the execution of the service, and
the processing element connected to the control unit carries out the function according to the task-execution transition information.

8. The processing system according to claim 7, wherein:
the communication section of the control unit makes an inquiry about the function information which is held in the other control unit, based on the judgment result about the execution of the service, and
the processing element which is connected to the other control unit also carries out the function according to the task-execution transition information.

9. A distributed processing method which uses a control unit and a processing element which carries out a specific function, comprising:
a data holding step in processing element of holding function information related to the specific function in the processing element;
a processing-element communication step of outputting to an outside the function information according to a request from an outside of the processing element; and
a control-unit communication step of outputting the function information according to a request from an outside of the control unit.

10. The distributed processing method according to claim 9, further comprising:
a date holding step in control unit of acquiring the function information of the processing element which is connected to the control unit, and holding the function information acquired in the control unit.

11. The distributed processing method according to claim 10, comprising:
a processing-element checking step of detecting the processing element that is connected to or disconnected from the control unit;
a processing-element connection information acquisition step of acquiring or updating processing-element connection information for controlling at least the function information of the processing element which is connected to the control unit;
a service-execution request receiving step of receiving an execution request related to a service;
a service-task correspondence information acquisition step of acquiring information which indicates a task which forms the service;
a service-execution judging step of judging about an execution of the service based on one of or both the function information and processing-element connection information related to the processing element which is connected to the control unit, by referring to the service-task corresponding information;
a task-execution transition information acquisition step of acquiring task-execution transition information for executing the task which forms the service, based on a judgment result of the service-execution judging step; and
a processing-element execution step of carrying out the function according to the task-execution transition information by the processing element which is connected to the control unit.

12. The distributed processing method according to claim 11, wherein at the processing-element connection information acquisition step, processing-element connection information related to another control unit within a predetermined range connected to the control unit is acquired or updated.

13. The distributed processing method according to claim 12, wherein the other control unit within the predetermined range connected to the control unit is determined based on a communication distance.

14. The distributed processing method according to claim 11, further comprising:
a processing-element securing step of securing the processing element for executing the task which forms the service, based on a judgment result of the service-execution judging step.

15. The distributed processing method according to claim 11, comprising:
a releasing step of releasing the processing element used in the service, when the processing-element execution step is completed.

16. The control unit according to claim 3, wherein the control unit detects the processing element connected to or disconnected from the control unit.

17. The distributed processing method according to claim 12, further comprising:
a processing-element securing step of securing the processing element for executing the task which forms the service, based on a judgment result of the service-execution judging step.

18. The distributed processing method according to claim 13, further comprising:
a processing-element securing step of securing the processing element for executing the task which forms the service, based on a judgment result of the service-execution judging step.

19. The distributed processing method according to claim 12, comprising:
a releasing step of releasing the processing element used in the service, when the processing-element execution step is completed.

20. The distributed processing method according to claim 13, comprising:
a releasing step of releasing the processing element used in the service, when the processing-element execution step is completed.
